(19) United States
(12) Patent Application Publication
(10) Pub. No.: US 2004/0215115 A1
(43) Pub. Date: Oct. 28, 2004

(54) Folding collapsible massaging bar

(76) Inventor: Jiann-Chern Sheen, Ping Tung City (TW)

Correspondence Address: PRO-TECHTOR INTERNATIONAL, 20775 Norada Court, Saratoga, CA, 95070-3018, US

(21) Appl. No.: 10/425,536

(22) Filed: Apr. 28, 2003

(51) Int. Cl. A61H 7/00

(52) U.S. Cl. 601/135; 601/133

(57) ABSTRACT

A folding collapsible massaging bar is constructed to include an operation bar, a bar of fulcrum, an extension bar, and a beater bar respectively pivoted to one another in series in such a manner that the operation bar and the bar of fulcrum define an obtuse angle, the bar of fulcrum and the extension bar define a right angle, and the extension bar and the beater bar define an acute angle when the folding collapsible massaging bar extended out.

### BACKGROUND OF THE INVENTION

1. Field of the Invention

The present invention relates to a massaging bar for massaging a part of the body and, more particularly, to a folding collapsible massaging bar, which is practical for massaging any part of the body and, can be received for carrying conveniently by the user.

2. Brief Description of the Related Art

Various massaging bars have been disclosed and, have appeared on the market. FIG. 1 illustrates a massaging bar according to the prior art. This design of massaging bar comprises a resilient wire rod 10, a handle 20 fixedly provided at one end of the resilient wire rod 10, and a massaging tip 30 fixedly provided at the other end of the resilient wire rod 10. This design of massaging bar produces less massaging effect. FIG. 2 shows another structure of massaging bar according to the prior art. The massaging bar is a smoothly arched bar having one end terminating in a handle 40 and the other end terminating in a massaging head 50. This structure of massaging bar must be operated in a particular direction. Further, the user must employ much effort to hit the massaging bar against the body when massaging. FIG. 3 shows still another structure of massaging bar according to the prior art. This structure of massaging bar is similar to the design shown in FIG. 2 with the exception of the use of a massaging wheel assembly 60 instead of the massaging head 50. This structure of massaging bar does not eliminate the drawbacks of the aforesaid two prior art designs. Further, the designs shown in FIGS. 1 and 2 are made to massage the body by “beating” but not “rubbing”. The design shown in FIG. 1 is made to massage the body by “rubbing” but not beating”.

### SUMMARY OF THE INVENTION

The present invention has been accomplished under the circumstances in view. It is the main object of the present invention to provide a massaging bar, which is folding collapsible. It is another object of the present invention to provide a folding collapsible massaging bar, which is practical for use to massage any part of the body. It is still another object of the present invention to provide a folding collapsible massaging bar, which is orthopedically engineered for easy operation with less effort.

To achieve these and other objects of the present invention, the folding collapsible massaging bar comprises an operation bar, the operation bar having a first end and a second end; a bar of fulcrum, the bar of fulcrum having a first end, a second end, and a receiving open chamber longitudinally disposed at an inner side thereof between the first end and the second end and adapted to accommodate the operation bar; first coupling means, which pivotally secures the second end of the operation bar to the first end of the bar of fulcrum for enabling the operation bar to be turned relative to the bar of fulcrum between an extended position and a received position within an obtuse angle; a beater bar, the beater bar having a first end and a second end; an extension bar, the extension bar having a first end, a second end, and a receiving open chamber longitudinally disposed at an inner side thereof between the first end and the second end and adapted to accommodate the beater bar; second coupling means, which pivotally secures the second end of the bar of fulcrum to the second end of the extension bar for enabling the bar of fulcrum and the extension bar to be turned relative to each other within 90° between an extended position and a received position; and third coupling means, which pivotally secures the second end of the beater bar to the first end of the extension bar for enabling the beater bar to be turned relative to the extension bar between an extended position and a received position within an acute angle.

### BRIEF DESCRIPTION OF THE DRAWINGS

FIG. 1 is an elevational view of a massaging bar according to the prior art.

FIG. 2 is an elevational view of another design of massaging bar according to the prior art.

FIG. 3 is an elevational view of still another design of massaging bar according to the prior art.

FIG. 4 is an exploded view of a folding collapsible massaging bar according to the first embodiment of the present invention.

FIG. 5 is an elevational assembly view of the folding collapsible massaging bar according to the first embodiment of the present invention.

FIG. 6 is a schematic drawing of the first embodiment of the present invention, showing the operation bar and the beater bar turned relative to the bar of fulcrum and the extension bar.

FIG. 7 is a top view of the first embodiment of the present invention, showing the folding collapsible massaging bar received in the collapsed condition.

FIG. 8 is an exploded view of a folding collapsible massaging bar according to the second embodiment of the present invention.

FIG. 9 is a perspective view in an enlarged scale of a part of the second embodiment of the present invention showing the locking mechanism locked.

FIG. 10 is a perspective view of a part of the third embodiment of the present invention.

FIG. 11 is similar to FIG. 10 but showing the locking mechanism locked.

FIG. 12 shows one application example of the present invention.

FIG. 13 shows another application example of the present invention.

FIG. 14 shows still another application example of the present invention.

FIG. 15 shows still another application example of the present invention.

FIG. 16 shows still another application example of the present invention.

FIG. 17 shows still another application example of the present invention.

### DETAILED DESCRIPTION OF THE PREFERRED EMBODIMENT

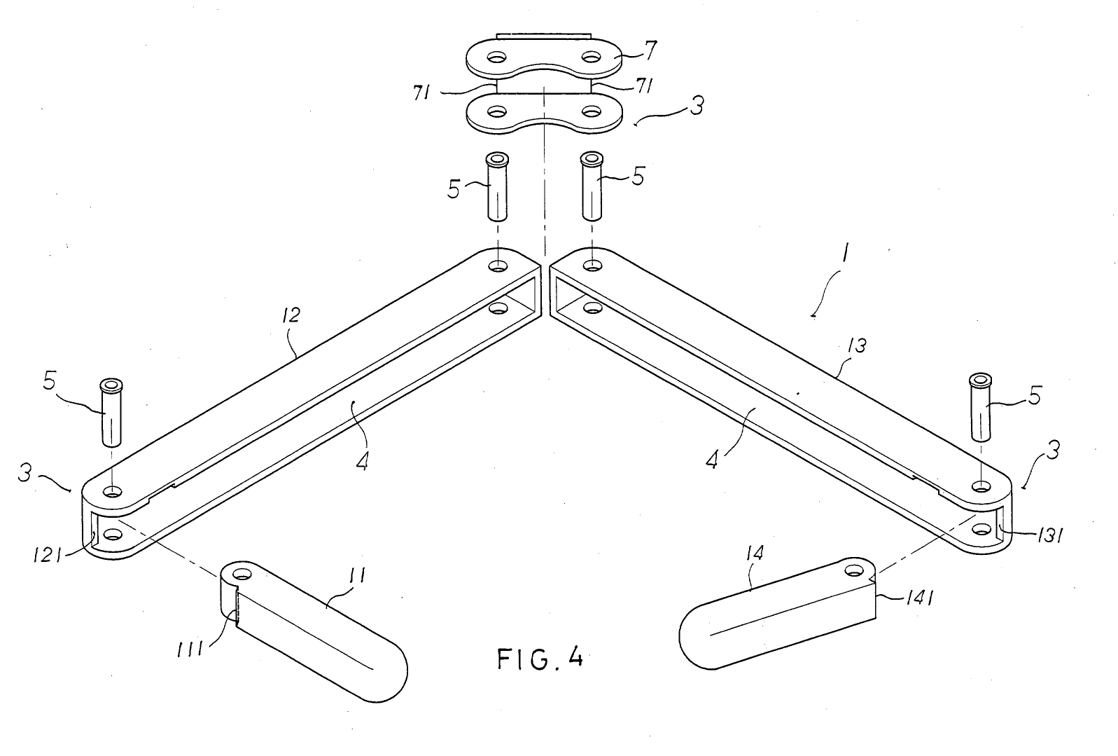

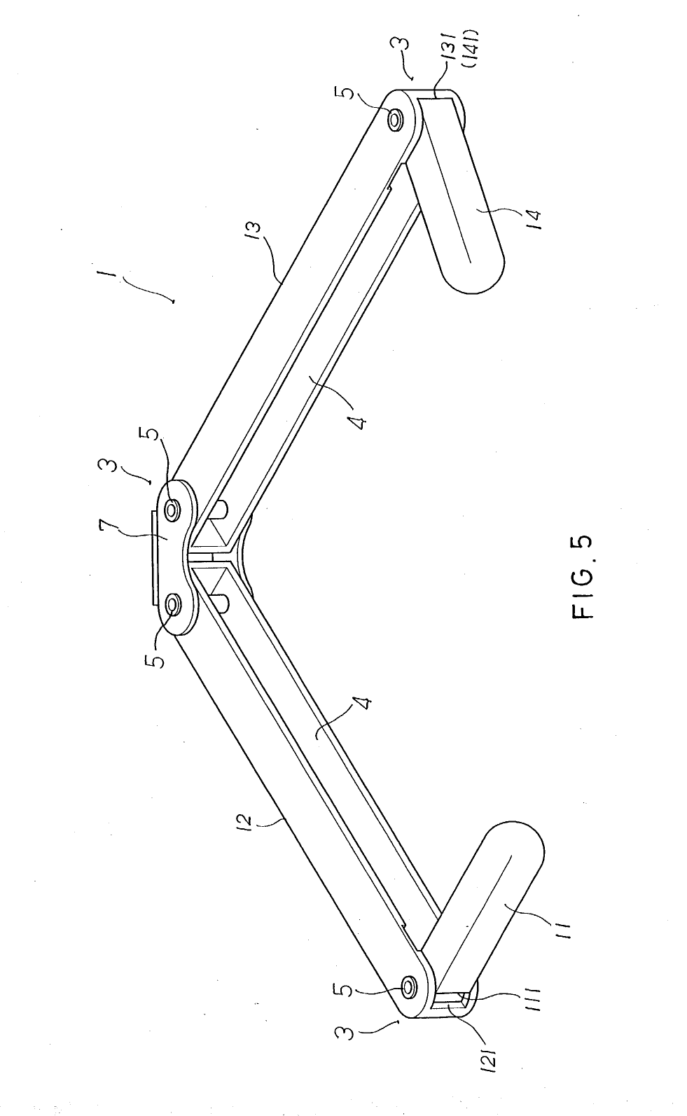

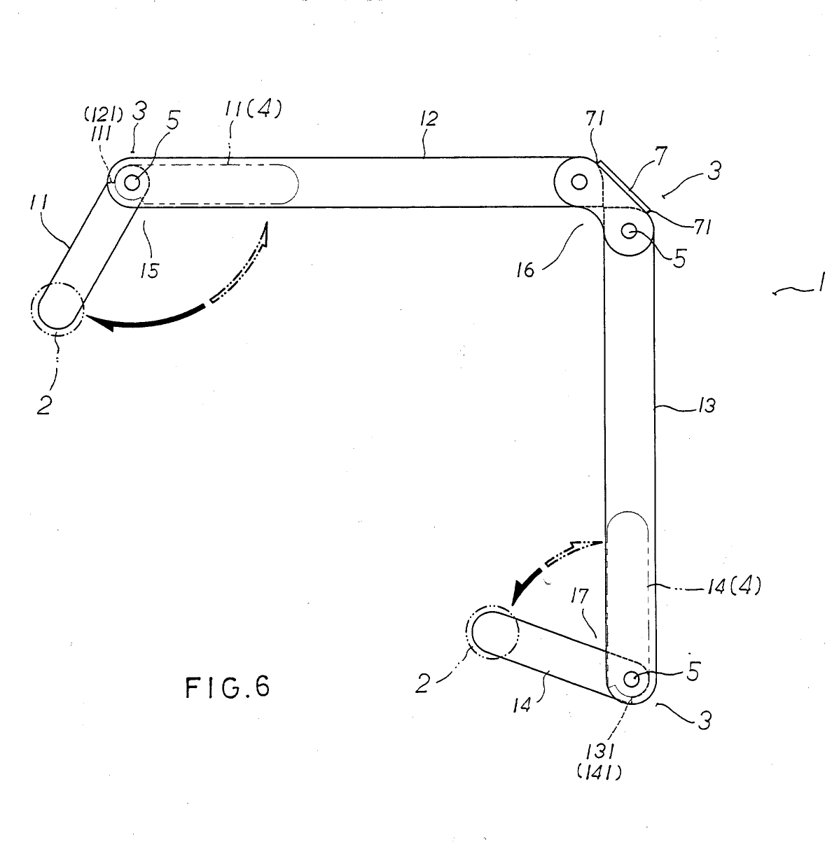

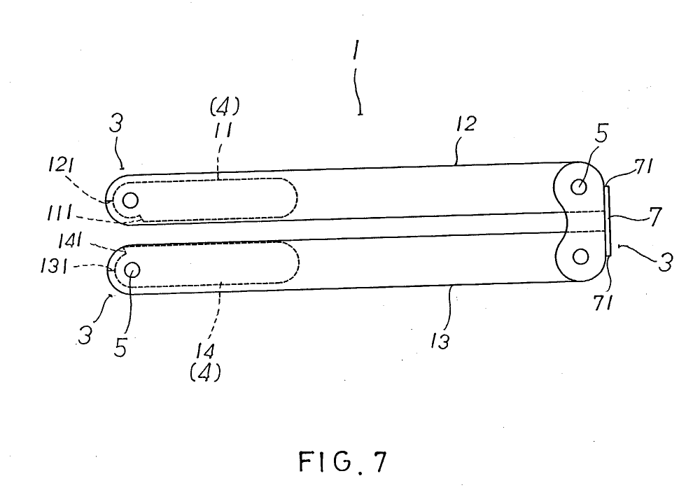

Referring to FIGS. 4-7, a folding collapsible massaging bar 1 in accordance with the first embodiment of the present invention is shown comprised of an operation bar 11, a bar of fulcrum 12, an extension bar 13, and a beater bar 14. The operation bar 11, the bar of fulcrum 12, the extension bar 13 and the beater bar 14 are connected to one another in series in a proper order by a respective pivot joint 3. When the folding collapsible massaging bar 1 extended out, the operation bar 11 and the bar of fulcrum 12 define an obtuse angle 15; the bar of fulcrum 12 and the extension bar 13 define a right angle 16; the extension bar 13 and the beater bar 14 define an acute angle 17. Further, the operation bar 11 and the beater bar 14 each have a rounded outer end 2 (see FIG. 6). When not in use, the folding collapsible massaging bar 1 can be folded up and received in a collapsed condition convenient for carrying by hand (see FIG. 7). The obtuse angle 15 defined between the operation bar 11 and the bar of fulcrum 12 is preferably set within 120˜135°. The acute angle 17 defined between the extension bar 13 and the beater bar 14 is preferably set within 70˜75°. Further, the bar of fulcrum 12 and the extension bar 13 each have a longitudinally extended receiving open chamber 4 adapted to accommodate the operation bar 11 or the beater bar 14. When not in use, the operation bar 11 or the beater bar 14 are respectively received in the receiving open chambers 4 of the bar of fulcrum 12 and the extension bar 13, and then the bar of fulcrum 12 and the extension bar 13 are turned inward toward each other and then closely attached to each other (see FIGS. 6 and 7).

The aforesaid pivot joint 3 may be variously embodied. According to this embodiment, the operation bar 11 and the beater bar 14 are respectively pivoted to the bar of fulcrum 12 and the extension bar 13 by a respective pivot 5. The operation bar 11 and the beater bar 14 each have a transversely extended retaining groove 111 or 141 near the respective inner end remote from the respective rounded outer end 2. The bar of fulcrum 12 and the extension bar 13 each have a transversely extended stop flange 121 or 131 near the respective outer end. When the operation bar 11 and the beater bar 14 are respectively extended out of the bar of fulcrum 12 and the extension bar 13, the respective transversely extended retaining grooves 111 and 141 are respectively forced into engagement with the respective stop flanges 121 and 131, and therefore the turning angle of the operation bar 11 relative to the bar of fulcrum 12 and the turning angle of the beater bar 14 relative to the extension bar 13 are limited. The pivot joint 3 which secures the bar of fulcrum 12 and the extension bar 13 is comprised of a coupling plate 7, which receives the inner end of the bar of fulcrum 12 and the inner end of the extension bar 13, and two pivots 5 respectively fastened to the coupling plate 7 and the bar of fulcrum 12 or extension bar 13. The coupling plate 7 has two stop edges 71 adapted to confine the turning action between the bar of fulcrum 12 and the extension bar 13 within 90°.

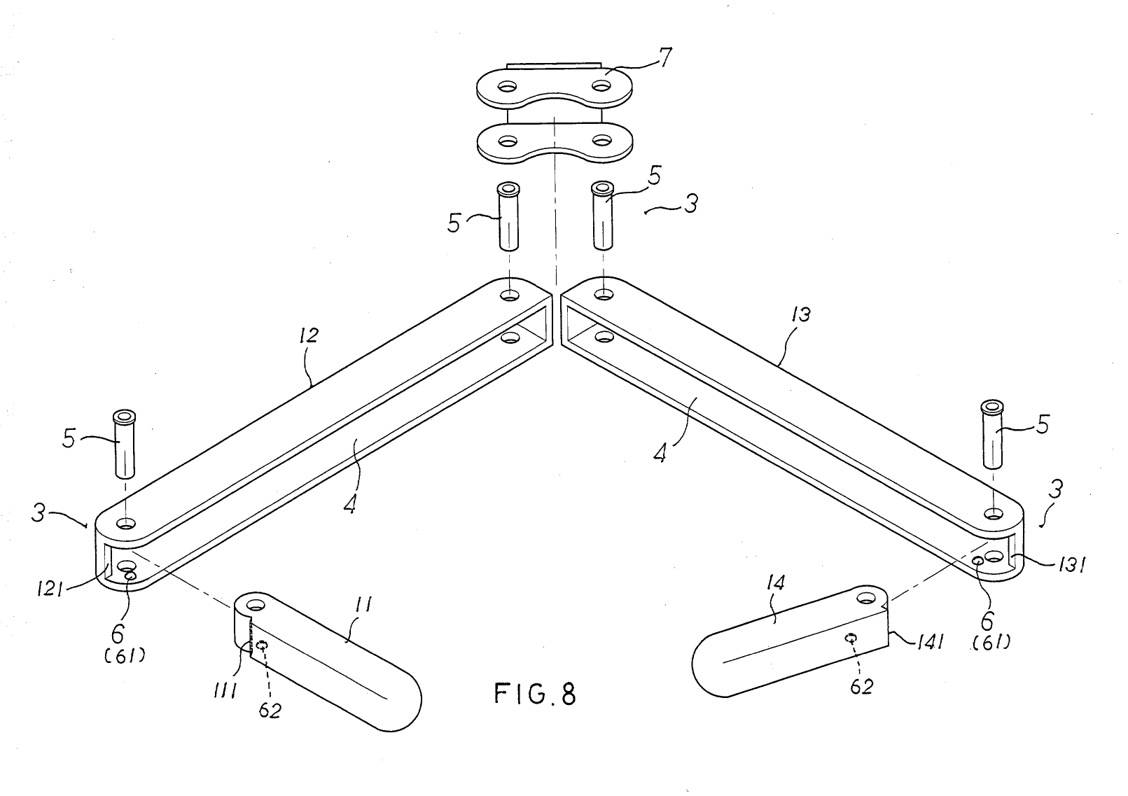

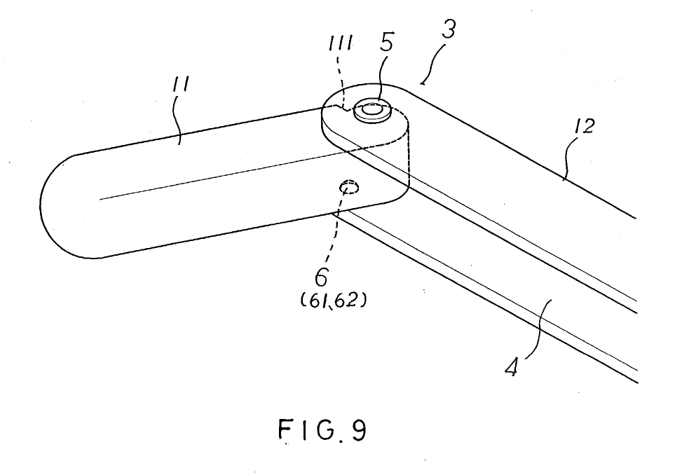

FIGS. 8 and 9 show a folding collapsible massaging bar according to the second embodiment of the present invention. This embodiment is similar to the aforesaid first embodiment with the exception of the arrangement of locking means to lock the operation bar 11 and the beater bar 14 in the respective extended position. As illustrated, two locking mechanisms 6 are provided for locking the operation bar 11 and the beater bar 14 in the respective extended position. Each locking mechanism 6 comprises a female retaining means (for example, a recessed retaining hole) 61 formed in the outer end of the bar of fulcrum 12 or extension bar 13 adjacent to the stop flange 121 or 131 and a male retaining means (for example, a stub retaining rod) protruded from the operation bar 11 or beater bar 14 for engaging the female retaining means 61.

FIGS. 10 and 11 are perspective views of a part of the third embodiment of the present invention. According to this embodiment, the locking mechanism 6 is comprised of a spring stop plate 63. The spring stop plate 63 has one end fixedly connected to the inside wall of the bar of fulcrum 12 (or the extension bar 13). When the operation bar 11 (or beater bar 14) extended out, the free end of the spring stop plate 63 is forced into engagement with a part of the inner end of the operation bar 11 (or beater bar 14) to lock the operation bar 11 (or beater bar 14) in the extended position. Further, the bar of fulcrum 12 (or extension bar 13) has a recessed receiving portion 64, which receives the spring stop plate 63 for enabling the operation bar 11 (or beater bar 14) to be turned between the extended position and the received position.

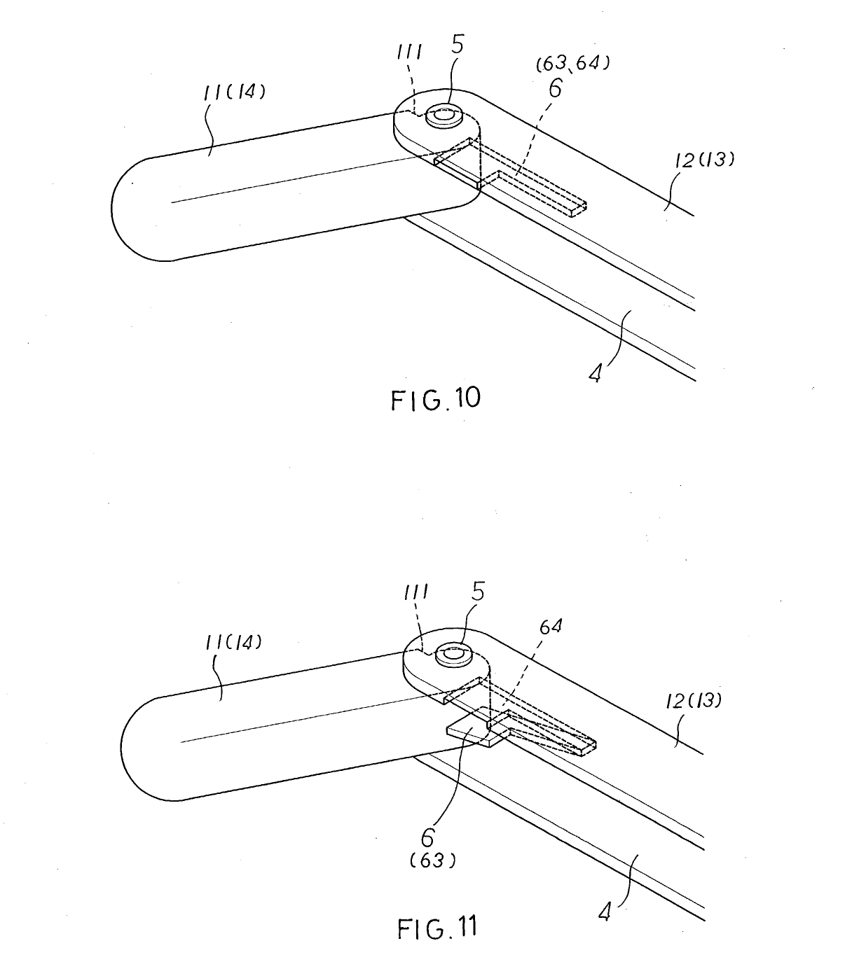

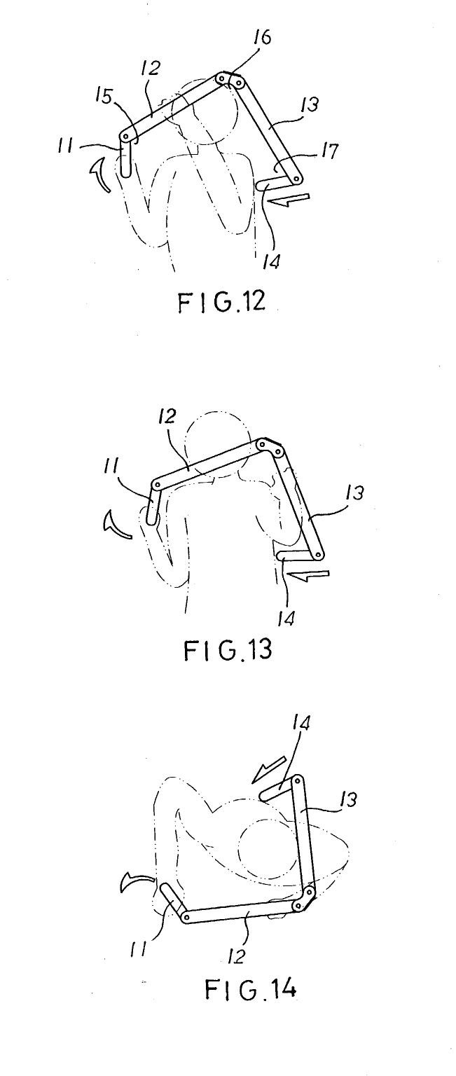

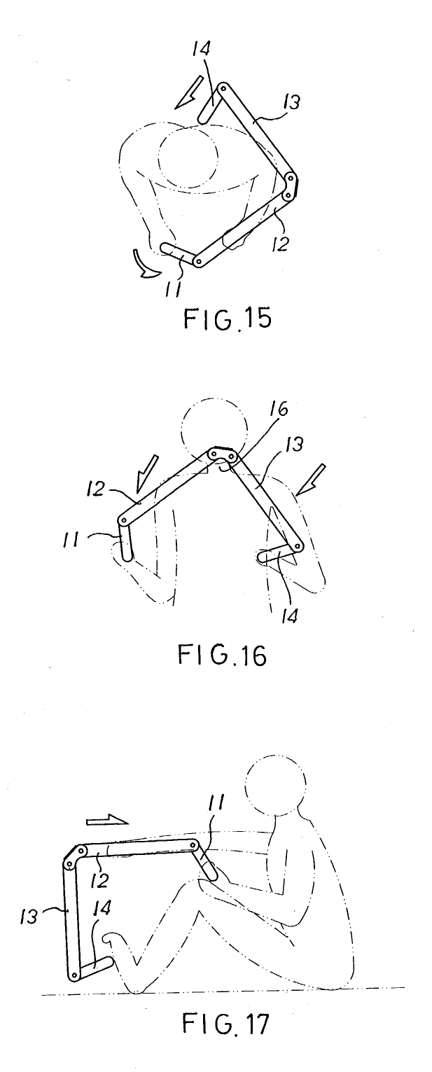

FIGS. 12˜17 show different application examples of the present invention to massage different parts of the body. When in use, hold the bar of fulcrum 12 with one hand, and then alternatively pull and push the operation bar 11 with the other hand. When alternatively pulling and pushing the operation bar 11, the beater bar 14 is driven to beat the assigned part of the body. Further, the user can selectively lock or unlock the operation bar 11 and the beater bar 14 as desired.

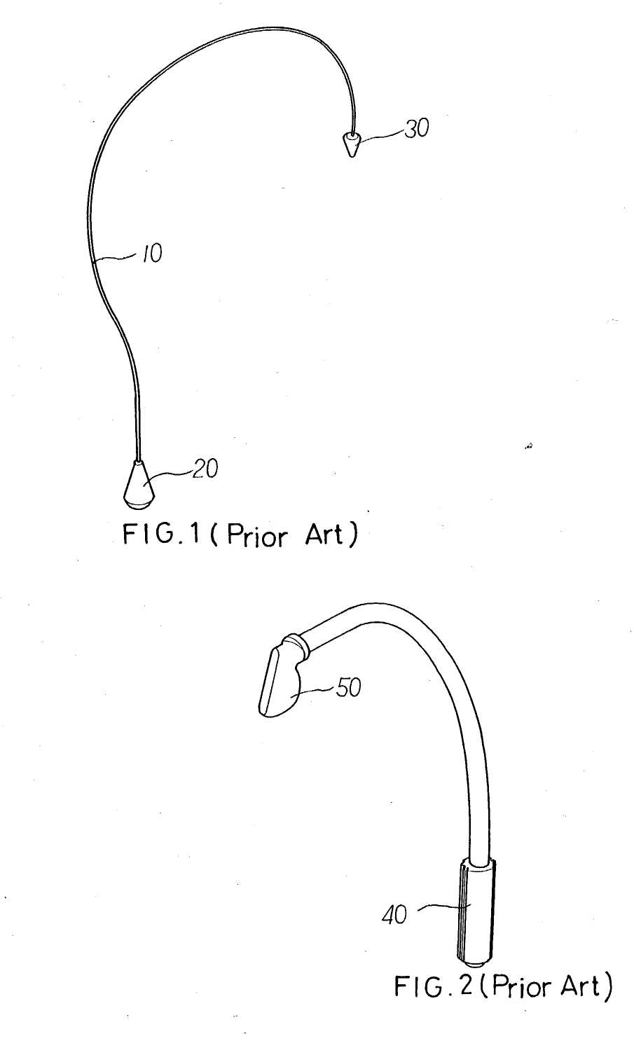

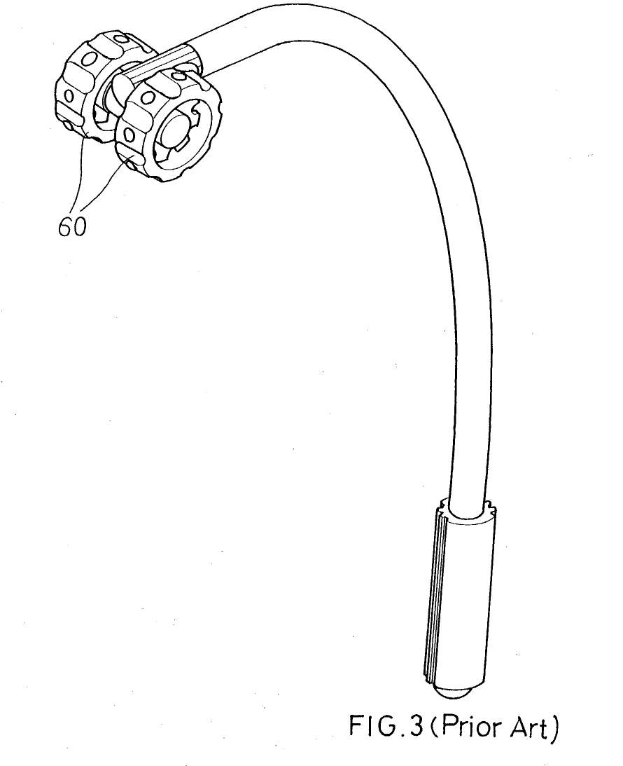

A prototype of folding collapsible massaging bar has been constructed with the features of FIGS. 1˜17. The folding collapsible massaging bar functions smoothly to provide all of the features discussed earlier.

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. A folding collapsible massaging bar comprising:
an operation bar, said operation bar having a first end and a second end;
a bar of fulcrum, said bar of fulcrum having a first end, a second end, and a receiving open chamber longitudinally disposed at an inner side thereof between the first end and the second end and adapted to accommodate said operation bar;
first coupling means, which pivotally secures the second end of said operation bar to the first end of said bar of fulcrum for enabling said operation bar to be turned relative to said bar of fulcrum between an extended position and a received position within an obtuse angle;
a beater bar, said beater bar having a first end and a second end;
an extension bar, said extension bar having a first end, a second end, and a receiving open chamber longitudinally disposed at an inner side thereof between the first end and the second end and adapted to accommodate said beater bar;
second coupling means, which pivotally secures the second end of said bar of fulcrum to the second end of said extension bar for enabling said bar of fulcrum and said extension bar to be turned relative to each other within 90° between an extended position and a received position; and
third coupling means, which pivotally secures the second end of said beater bar to the first end of said extension bar for enabling said beater bar to be turned relative to said extension bar between an extended position and a received position within an acute angle.

2. The folding collapsible massaging bar as claimed in claim 1, wherein the first end of said operation bar and the first end of said beater bar are respectively rounded.

3. The folding collapsible massaging bar as claimed in claim 1, wherein said obtuse angle is preferably within about 120˜135°, and said acute angle is preferably within about 70˜75°.

4. The folding collapsible massaging bar as claimed in claim 1, wherein said first coupling means comprises a pivot pivotally fastened to the second end of said operation bar and the first end of said bar of fulcrum, a retaining groove transversely extended in one side of the second end of said operation bar, and a stop flange transversely extended in the first end of said bar of fulcrum and adapted to engage said retaining groove to stop said operation bar in the extended position.

5. The folding collapsible massaging bar as claimed in claim 1, wherein said second coupling means comprises a coupling plate, which receives the second end of said bar of fulcrum and the second end of said extension bar, a first pivot pivotally fastened to said coupling plate and the second end of said bar of fulcrum, and a second pivot pivotally fastened to said coupling plate and the second end of said extension bar, said coupling plate having two stop edges adapted to stop a part of the second end of said bar of fulcrum and the second end of said extension bar when said bar of fulcrum and said extension bar are turned outwards from each other.

6. The folding collapsible massaging bar as claimed in claim 1, wherein said third coupling means comprises a pivot pivotally fastened to the second end of said beater bar and the first end of said extension bar, a retaining groove transversely extended in one side of the second end of said beater bar, and a stop flange transversely extended in the first end of said extension bar and adapted to engage the retaining groove at said beater bar and to further stop said beater bar in the extended position.

7. The folding collapsible massaging bar as claimed in claim 1, further comprising a first locking mechanism and a second locking mechanism adapted to lock said operation bar and said beater bar in the extended position respectively, said first locking mechanism comprising a female retaining means formed in the first end of said bar of fulcrum and a male retaining means protruded from the second end of said operation bar for engaging the female retaining means the first end of said bar of fulcrum, said second locking mechanism comprising a female retaining means formed in the first end of said extension bar and a male retaining means protruded from the second end of said beater bar for engaging the female retaining means the first end of said extension bar.

8. The folding collapsible massaging bar as claimed in claim 1, further comprising a first locking mechanism and a second locking mechanism adapted to lock said operation bar and said beater bar in the extended position respectively, said first locking mechanism comprising a spring stop plate extended from an inside wall of said bar of fulcrum and adapted to stop against one side of the second end of said operation bar and to further lock said operation bar in the extended position and a recessed receiving portion formed in said bar of fulcrum for receiving the spring stop plate of said first locking mechanism for enabling said operation bar to be turned relative to said bar of fulcrum between the extended position and the received position, said second locking mechanism comprising a spring stop plate extended from an inside wall of said extension bar and adapted to stop against one side of the second end of said beater bar and to further lock said beater bar in the extended position and a recessed receiving portion formed in said extension bar for receiving the spring stop plate of said second locking mechanism for enabling said beater bar to be turned relative to said extension bar between the extended position and the received position.
